(19) United States
(12) Patent Application Publication
(10) Pub. No.: US 2024/0184473 A1
(43) Pub. Date: Jun. 6, 2024

(54) VERIFICATION OF ASYNCHRONOUSLY MIRRORED REMOTE DATA

(71) Applicant: INTERNATIONAL BUSINESS MACHINES CORPORATION, ARMONK, NY (US)

(72) Inventors: David Michael Shackelford, Tucson, AZ (US); Nadim P. Shehab, TUCSON, AZ (US); Alan George McClure, Sahuarita, AZ (US); KARL GUSTAV SIIK, Saltsjoe-Duvnaes (SE); Jose Ricardo Fernandez, Cary, NC (US)

(21) Appl. No.: 18/062,187

(22) Filed: Dec. 6, 2022

(51) Int. Cl. G06F 3/06

(52) U.S. Cl. CPC G06F 3/065; G06F 3/0665; G06F 3/0679; G06F 3/0604

(57) ABSTRACT

A computer-implemented method for a mirror volume comparison is provided. The computer-implemented method includes executing asynchronous remote mirroring between a primary site and a secondary site, making a first flash copy of first data at the primary site, executing asynchronous remote copying of the first flash copy to a replica at the secondary site, making a second flash copy of second data at the secondary site and performing an on-demand compare of the replica with the second flash copy to verify an accuracy of the asynchronous remote mirroring.

### BACKGROUND

The present invention generally relates to global mirroring, and more specifically, to verification of asynchronously mirrored remote data.

In global mirror (GM) technologies, data is asynchronously mirrored from a primary storage system to a secondary storage system in order to maintain two consistent copies of data. The primary and secondary storage systems may be located at different sites, perhaps hundreds or thousands of miles away from one another.

The original disk (primary) and copy (secondary) can be compared to verify the accuracy of the mirror technology when both disks are accessible from the same system, but direct comparison is not possible when no system has access to both disks. A mirroring technology also presents comparison difficulties because both disks are continuously changing, and the changes happen at different times.

No method currently exists to compare two continuously changing sets of data which are not accessible from the same system.

### SUMMARY

Embodiments of the present invention are directed to a computer-implemented method for a mirror volume comparison. Non-limiting embodiments of the computer-implemented method include executing asynchronous remote mirroring between a primary site and a secondary site, making a first flash copy of first data at the primary site, executing asynchronous remote copying of the first flash copy to a replica at the secondary site, making a second flash copy of second data at the secondary site and performing an on-demand compare of the replica with the second flash copy to verify an accuracy of the asynchronous remote mirroring.

Embodiments of the present invention are directed to a computer-implemented method for a mirror volume comparison. Non-limiting embodiments of the computer-implemented method include executing asynchronous remote mirroring between a primary site and a secondary site while holding off on updates to first data at the primary site. A first flash copy of the first data is made at the primary site while monitoring that all updates that were made to the first data before holding off are asynchronously remotely mirrored to second data at the secondary site. A second flash copy of the second data is made at the secondary site and updates to the first data are allowed to resume. The first flash copy is asynchronously remotely copied to a replica at the secondary site. An on-demand and repeatable static compare is then performed between the replica and the second flash copy. The static compare can be done on all data since the data on the replica and the second flash copy represent data of the same point in time. The performing of the on-demand and repeatable static compare provides for verification of an accuracy of the asynchronous remote mirroring between the primary site and the secondary site.

Embodiments of the invention further provide computer program products and computer systems having substantially the same features and technical benefits as the above-described computer-implemented methods.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 is a schematic illustration of a storage environment in accordance with one or more embodiments of the present invention;

FIG. 2 is a schematic illustration of components of a server of the storage environment of FIG. 1 in accordance with one or more embodiments of the present invention;

FIG. 3 is a flow diagram illustrating a computer-implemented method for a mirror volume comparison in accordance with one or more embodiments of the present invention;

FIG. 4 is a schematic illustration of a mirroring operation in accordance with one or more embodiments of the present invention;

FIG. 5 is a schematic illustration of a flash copy of first data of the mirroring operation of FIG. 4 in accordance with one or more embodiments of the present invention;

FIG. 6 is a schematic illustration of a mirroring of the flash copy of the first data of the mirroring operation of FIGS. 4 and 5 in accordance with one or more embodiments of the present invention;

FIG. 7 is a schematic illustration of a flash copy of second data of the mirroring operation of FIGS. 4-6 in accordance with one or more embodiments of the present invention;

FIG. 8 is a schematic illustration of a comparison of a flash copy of first data and a flash copy of second data of the mirroring operation of FIGS. 4-7 in accordance with one or more embodiments of the present invention;

FIGS. 9A and 9B are flow diagrams illustrating a more detailed version of computer-implemented method of FIG. 3 for a mirror volume comparison in accordance with one or more embodiments of the present invention; and

FIG. 10 is a schematic diagram of a computing environment for implementing one or more embodiments of the present invention.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two or three digit reference numbers. With minor exceptions, the leftmost digit(s) of each reference number correspond to the figure in which its element is first illustrated.

### DETAILED DESCRIPTION

Turning now to an overview of technologies that are more specifically relevant to aspects of the invention, data backup systems can provide continuous availability of production data in the event of a sudden catastrophic failure at a single point in time or data loss over a period of time. In one such disaster recovery system, production data is replicated from a local site to a remote site which may be separated geographically by several miles from the local site. Such dual, mirror or shadow copies are typically made in a secondary (or target) storage device at the remote site, as the application system is writing new data to a primary (or source) storage device usually located at the local site. Different data replication technologies may be used for maintaining remote copies of data at a secondary site, such as International Business Machine Corporation's (“IBM”) Metro Mirror Peer to Peer Remote Copy (PPRC), Extended Remote Copy (XRC), Coupled XRC (CXRC), Global Copy, and Global Mirror.

For an asynchronous mirroring operation, successful updates to the primary storage are typically reported to a host system updating the primary storage as a successful storage I/O operation without waiting for the update to be mirrored to the secondary storage. As a result, the host need not wait for the updated data to be mirrored before continuing with operations.

Current systems may run a verification program periodically in a system separate from a source and target storage servers to determine whether asynchronous mirroring is operating successfully. These systems read source data units and compare them to target data units in the target or secondary storage that are in a mirror copy relationship. If there is a match for the data being mirrored, then the mirror operation is verified as successfully operating. If the comparison does not match, then the verification operation will continue to reread the source and target data to compare with the target data until matches are determined. If no match is determined after a predetermined number of reread attempts, then the mirroring operation cannot be verified.

There remains, however, a continuing need for improved techniques for verifying the operation of data mirroring with respect to data in a mirror copy relationship.

Turning now to an overview of the aspects of the invention, one or more embodiments of the invention address shortcomings of the above-described approach by providing for on demand independent verification of asynchronous mirroring technology without giving any one entity access to primary and secondary global mirroring sites.

The above-described aspects of the invention address the shortcomings of known approaches by providing for a global mirror volume comparison including executing global mirroring between a primary site and a secondary site, making a first flash copy of first data at the primary site to stop the first data from being updated, mirroring the first flash copy to a second flash copy at the secondary site, making a flash copy of second data at the secondary site, resuming updates to the first data and performing an on-demand compare of the first flash copy with the second flash copy to verify an accuracy of the global mirroring.

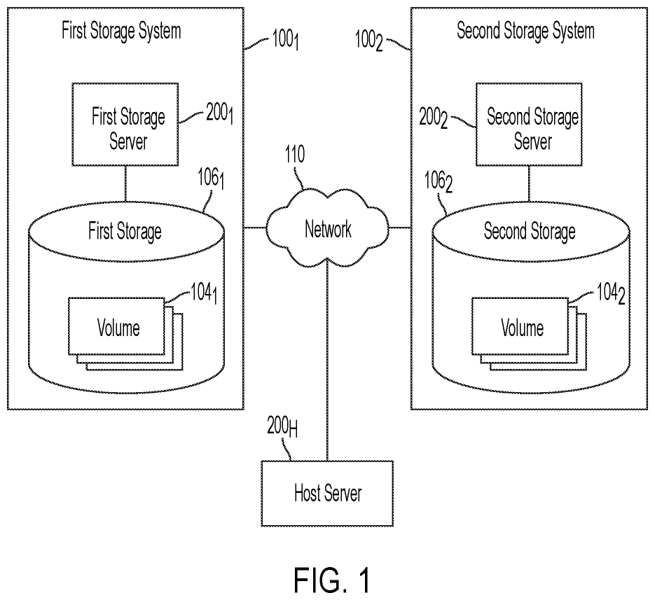

With reference to FIG. 1, a data storage environment is provided and has at least two storage systems 100₁ and 100₂, each including storage servers 200₁ and 200₂, respectively, managing access to volumes 104₁ and 104₂ configured in storages 106 and 106₂. A host server 200_{H} manages data mirroring and data verification operations for data mirrored from the first storage system 100₁ to the second storage system 100₂. Host systems (not shown) may perform read and write operations with respect to the first storage system 100₁ over a storage network 110. The first storage 106₁, also referred to as a primary storage or source storage, may include a primary production volume to which hosts direct read and write request. The first storage server 200₁ may mirror data in the volumes 104₁ to the second storage system 100₂, also referred to as a secondary storage or target storage, to maintain data in consistency groups at the second storage server 200₂.

As used herein, the term “storage system” refers to a storage server 200₁, 200₂ and/or the storage 106₁, 106₂ managed by the server.

The storages 106₁, 106₂ may include different types or classes of storage devices, such as magnetic hard disk drives, solid state storage device (SSD) including solid state electronics, electrically erasable programmable read-only memory (EEPROM), flash memory, flash disk, random access memory (RAM) drive, storage-class memory (SCM), etc., phase change memory (PCM), resistive random access memory (RRAM), spin transfer torque memory (STM-RAM), conductive bridging RAM (CBRAM), magnetic hard disk drive, optical disk, tape, etc. The volumes 104₁, 104₂ may further be configured from an array of devices, such as just a bunch of disks (JBOD), direct access storage devices (DASDs), redundant arrays of independent disks (RAIDs) array, virtualization device, etc. Further, the storages 106₁, 106₂ may include heterogeneous storage devices from different vendors and different types of storage devices, such as a first type of storage devices, e.g., hard disk drives, that have a slower data transfer rate than a second type of storage devices, e.g., SSDs.

The storage network 110 used by the storage systems 100₁ and 100₂ to mirror data may include a storage network such as one or more interconnected local area networks (LANs), storage area networks (SANs), wide area networks (WANs), peer-to-peer networks, wireless networks, etc.

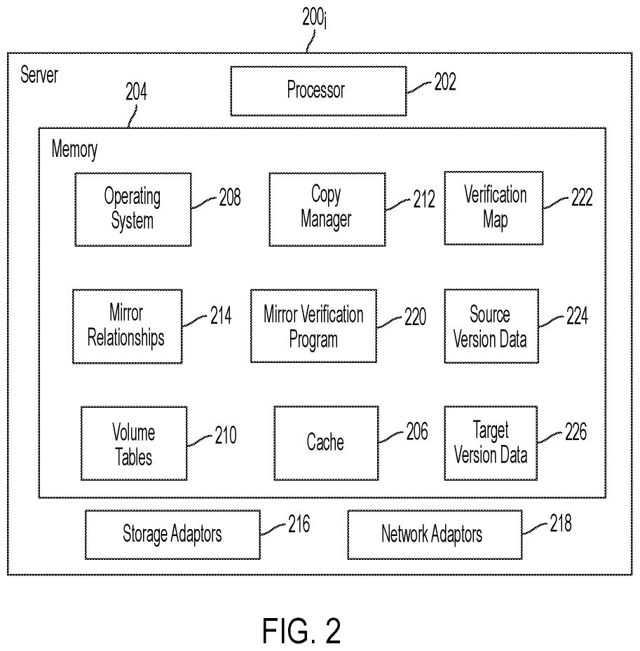

With reference to FIG. 2, a server 200; is involved in data mirroring, and can be provided as a first server, a second server and host server 200_{H} of FIG. 1. The server 200ᵢ includes a processor 202 and a memory 204 including programs executed by the processor 202 as well as a cache 206 to cache read and write data for the first storage 106₁. A portion of the cache 206 may also be used to transfer mirror data in a consistency group.

The memory 204 includes an operating system 208, which forms or establishes volumes 104₁ and maintains volume tables 210, such as a volume table of contents (VTOC), a file allocation table, etc., providing information on the configured volumes 104₁. The operating system 208 further manages I/O requests with respect to the volumes 104₁.

The memory 204 includes a copy manager 212 to create and manage mirror relationships 214 of source data units in volumes 104₁ in the first storage system 100₁, also referred to as source storage, to target data units in the second storage system 100₂, also referred to as the target storage, as part of consistency groups. In one embodiment, the first storage system 100₁ may have the source storage and the second storage system 100₂ may have the target storage of mirror copy relationships to mirror source volumes or other data units to corresponding target volumes or data units.

The server 200ᵢ further includes one or more storage adaptors 216 to communicate with devices in the storage 106₁ and one or more network adaptors 218 to communicate with the network 110 and manage the transfer of source data being mirrored to target data in a mirror copy relationship.

FIG. 2 also shows components that may be included at the server or component performing the verification operations, e.g., host server 200_{H} of FIG. 1, including a mirror verification program 220 to verify whether the mirror relationship 214 is functioning properly, a verification map 222, such as a bitmap, used by the mirror verification program 220, to indicate whether mirroring has been verified with respect to source data units in the first storage 106₁ mirrored to corresponding target data units 204₂, source version data 224 to store versions of source data units read while verifying the mirroring operations and target version data 226 to store versions of target data units read while verifying the mirroring operations.

A source data unit indicated in the verification map 222 may include any unit of data maintained in a volume 104₁, such as a track, cylinder of tracks, extent, etc. The source version data 224 and the target version data 226 may be stored at a separate location from where the target data units are stored for the volumes 1042 in the second storage 106₁, such as in a separate log file or side-file.

In one embodiment, the verification components 220, 222, 224 and 226 are implemented on the host server 200_{H} to verify that the mirroring is working. In an alternative embodiment, the verification components 220, 222, 224 and 226 may be maintained on the source server 200₁, the target server 200₂ or another storage server, which is neither source nor target, such as an appliance for analyzing data, etc., to verify that the mirroring is working by reading target data units from the second storage 1062 to compare with corresponding source data units in the first storage 106₁. In embodiments where the verification components are on the source 200₁ or target 200₂ server, the host server 200_{H} of FIG. 1 may still manage the mirroring operations.

The components in the memory 204 can be provided as program code loaded into the memory 204 and executed by the processor 202. Alternatively, some or all of the component functions may be implemented in hardware devices, such as in application specific integrated circuits (ASICs), field programmable gate arrays (FPGAs) or can be executed by separate dedicated processors.

The memory 204 may include one or more memory devices volatile or non-volatile, such as a dynamic random access memory (DRAM), a phase change memory (PCM), magnetoresistive random-access memory (MRAM), spin transfer torque (STT)-MRAM, SRAM storage devices, DRAM, a ferroelectric random-access memory (FeTRAM), nanowire-based non-volatile memory, and non-volatile direct in-line memory modules (DIMMs), NAND storage, e.g., flash memory, solid state drive (SSD) storage, non-volatile RAM, etc.

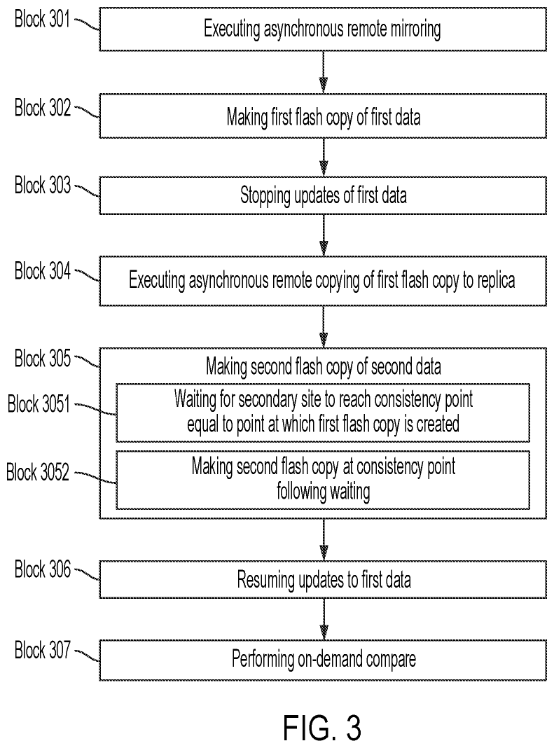

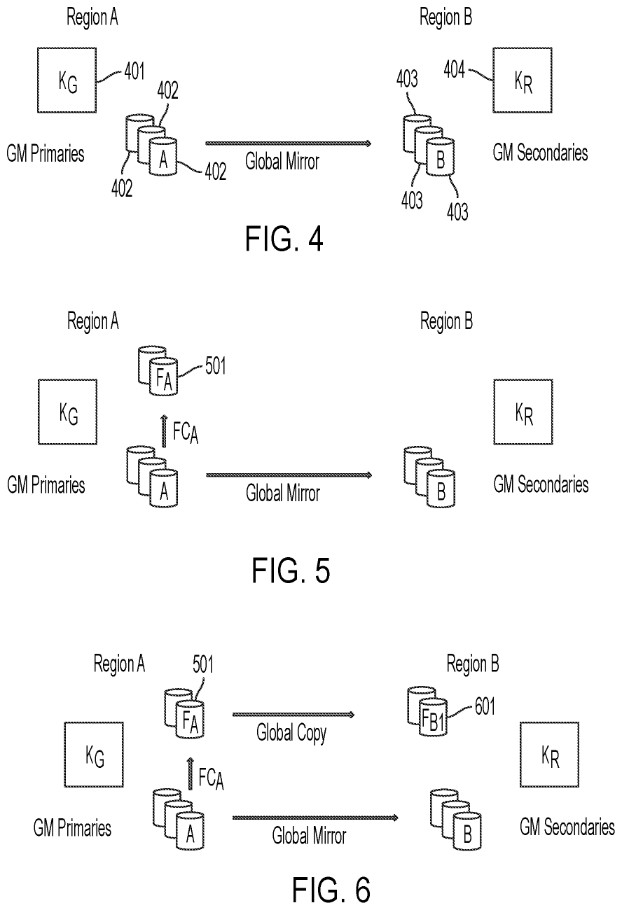

With reference to FIG. 3 and with additional reference to FIGS. 4-8, a computer-implemented method 300 is provided for executing a mirror volume comparison.

The computer-implemented method 300 of FIG. 3 includes executing asynchronous remote mirroring between a primary site and a secondary site at block 301. This is schematically illustrated in FIG. 4, which shows that data of a computer system 401 at the primary site (Region A) is stored in one or multiple volumes 402 and is asynchronously remotely mirrored to one or multiple volumes 403 at the secondary site (Region B) to generate data of a computer system 404 at the secondary site. This asynchronous remote mirroring of the data of the computer system 401 to the data of the computer system 404 needs to be verified for accuracy, but the verification should not be done when load is being transferred or by giving any one entity access to both sets of data of the computer system 401 and data of the computer system 404.

The computer-implemented method 300 of FIG. 3 also includes making a first flash copy of first data at the primary site at block 302 and stopping, in a corresponding or automatic manner, the first data from being updated at block 303. These operations are illustrated schematically in FIG. 5, which shows the making of the first flash copy 501 of the first data in the primary site (Region A). The making of the first flash copy 501 is instantaneous or nearly instantaneous and has a characteristic or associated time stamp. The stopping of the first data from being updated in the corresponding or automatic manner is temporary and serves to hold off on changes being made to the first data while certain operations described herein are executed.

The computer-implemented method 300 of FIG. 3 also includes executing asynchronous remote copying of the first flash copy to a replica at the secondary site at block 304. This operation is illustrated schematically in FIG. 6, which shows the execution of the asynchronous remote copying of the first flash copy 501 to the replica 601 at the secondary site (Region B). The asynchronous remote copying of the first flash copy 501 to the second flash copy 601 is asynchronous and non-instantaneous and does not have to be done while the updates of the first data continue to be stopped or held off. In a parallel operation, the draining of data from the volumes 402 at the primary site to the volumes 403 at the secondary site can be monitored.

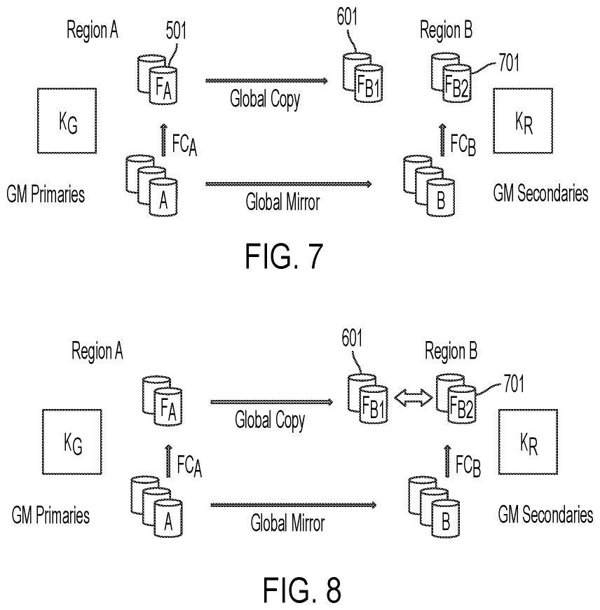

The computer-implemented method 300 of FIG. 3 also includes making a second flash copy of second data at the secondary site at block 305 and subsequently resuming updates to the first data at the primary site at block 306. This operation is illustrated schematically in FIG. 7, which shows the making of the second flash copy 701 of the second data in the secondary site (Region B). The making of the second flash copy 701 can be but need not be instantaneous or nearly instantaneous. In some embodiments, the making of the second flash copy 701 of the second data at the secondary site can include making an in-band or remote flash copy at a particular point in time (i.e., with a characteristic timestamp) but without a pause in updates to the second data. The resumption of updates to the first data can include a release of an extended long busy (ELB) hold on the first data.

In accordance with one or more embodiments of the present invention and as shown in FIG. 3, the making of the second flash copy of block 305 can include waiting for the secondary site to reach a consistency point equal to a point at which the first flash copy is created at block 3051 and making the second flash copy at the consistency point following the waiting at block 3052.

In accordance with one or more embodiments of the present invention, the making of the first flash copy of the first data at the primary site of block 302 can include making first flash copies of multiple volumes of the first data, the asynchronous remote copying of the first flash copy to the replica at the secondary site of block 304 can include asynchronously remotely copying the first flash copies to multiple replicas, the making of the second flash copy of the second data at the secondary site of block 305 can include making flash copies of multiple volumes of the second data and scheduling each of these operations with a goal of using minimal resources for minimal times (i.e., when other updates or transmission loads are not being executed or transmitted). In these or other cases, the multiple volumes of the second data correspond to the multiple volumes of the first data.

The computer-implemented method 300 of FIG. 3 also includes performing at block 307 an on-demand comparison of the replica with the second flash copy to verify an accuracy of the asynchronous remote mirroring of block 301. This on-demand compare can be a static and repeatable compare of the replica with the second flash copy and is illustrated schematically in FIG. 8, which shows the replica 601 and the second flash copy 701 being compared with one another. To whatever extent the replica 601 and the second flash copy 701 do not match for corresponding timestamps, it would thus be known that there are errors in the asynchronous remote mirroring of block 301.

While FIGS. 4-8 illustrate certain embodiments of remote mirroring, it is to be understood that other embodiments exist within the scope of this description. These include, but are not limited to, remote mirroring in a 3-site multi-target topology in which first data at a primary site is asynchronously remotely mirrored to a secondary site and a flash copy (with an update freeze) is asynchronously remotely copied to the secondary site, remote mirroring in a 3-site cascaded topology in which a flash copy (with an update freeze) of first data at a primary site is asynchronously remotely copied to a secondary site and a synchronous copy of the first data at the primary site is asynchronously remotely mirrored to a secondary site, remote mirroring in a 3-site cascaded topology in which a synchronous copy of first data is made at a primary site and is asynchronously remotely mirrored to a secondary site and in which a flash copy (with an update freeze) of the first data is made at the primary site and is asynchronously remotely copied to a secondary site, remote mirroring in a 3-site multi-target topology in which a synchronous copy of first data is made at a primary site and an original production of the first data is asynchronously remotely mirrored to a secondary site and in which a flash copy (with an update freeze) of the original production of the first data is made at the primary site and is asynchronously remotely copied to a secondary site, remote mirroring in a 3-site cascaded topology in which a synchronous copy of first data is made at a primary site and is asynchronously remotely mirrored to a secondary site and an original production of the first data is made into a flash copy (with an update freeze) at the primary site and is asynchronously remotely copied to a secondary site and remote mirroring in a 3-site cascaded topology in which a synchronous copy of first data is made at a primary site and is asynchronously remotely mirrored to a secondary site and made into a flash copy (with an update freeze) and asynchronously remotely copied to the secondary site.

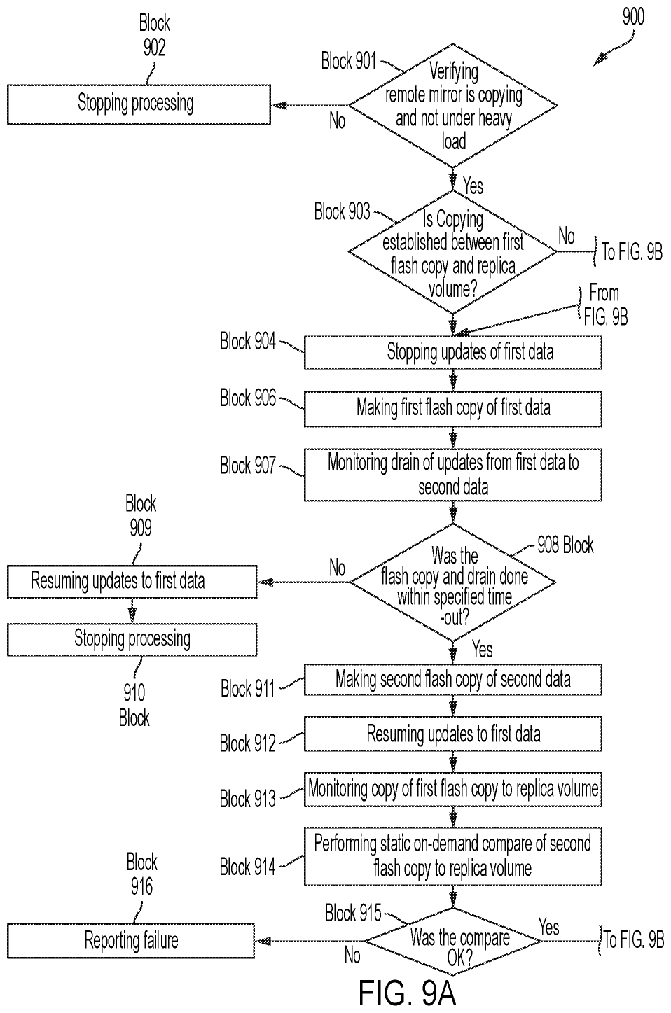

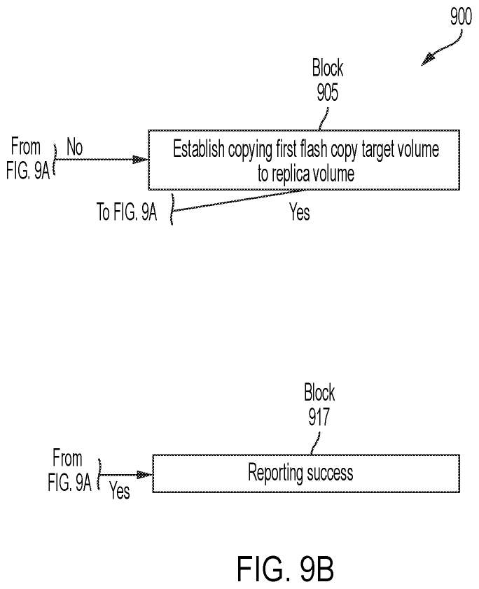

With reference to FIG. 9, a computer-implemented method 900 is provided for executing a mirror volume comparison. As shown in FIG. 9, the computer-implemented method 900 includes verifying that asynchronous remote mirroring is occurring and is not under a heavy load at block 901. If the asynchronous remote mirroring is not occurring properly or if a heavy load is present, the asynchronous remote mirroring is stopped at block 902. If the verifying is positive, it is determined whether copying has been established between a first flash copy and a replica at block 903. If so, control proceeds to block 904 whereupon updates to first data are stopped and, if not, the copying of the first flash copy to the replica is started at block 905 with control then proceeding to block 904. Once the updates are stopped at block 904, a first flash copy of first data is made at block 906 and a drain of updates from the first data to second data are monitored at block 907. At this point, it is determined whether the making of the first flash copy and the draining of updates were completed within a specified time-out at block 908. If not, updates the first data are resumed at block 909 and processing is stopped at block 910. If so, a second flash copy of second data is made at block 911, updates to the first data are resumed at block 912, copying of the first flash copy to the replica are monitored at block 913 and a static and repeatable on-demand compare of the replica and the second flash copy is performed at block 914. At block 915, it is determined whether results of the compare are ok and, if not, a failure is reported at block 916. If the results are deemed ok, success is reported at block 917.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

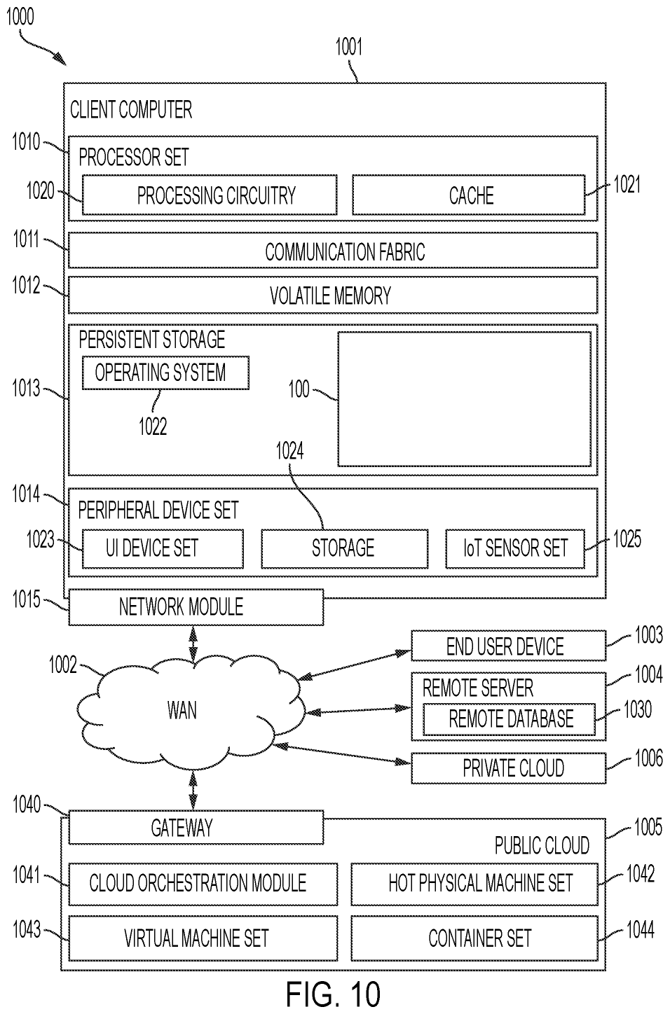

With reference to FIG. 10, a computer or computing device 1000 that implements the computer-implemented method 300 of FIG. 3 and/or the computer-implemented method 900 of FIG. 9 is provided in accordance with one or more embodiments of the present invention is provided. The computing system of FIG. 10 contains an example of an environment for the execution of at least some of the computer code involved in performing the inventive methods, such as the block of the computer-implemented method 300 of FIG. 3 and/or the computer-implemented method 900 of FIG. 9 for a mirror volume comparison. In addition to the computer-implemented method 300 and/or the computer-implemented method 900 of FIG. 9, the computing system 1000 includes, for example, computer 1001, wide area network (WAN) 1002, end user device (EUD) 1003, remote server 1004, public cloud 1005, and private cloud 1006. In this embodiment, computer 1001 includes processor set 1010 (including processing circuitry 1020 and cache 1021), communication fabric 1011, volatile memory 1012, persistent storage 1013 (including operating system 1022 and the computer-implemented method 300 and/or the computer-implemented method 900, as identified above), peripheral device set 1014 (including user interface (UI) device set 1023, storage 1024, and Internet of Things (IOT) sensor set 1025), and network module 1015. Remote server 1004 includes remote database 1030. Public cloud 1005 includes gateway 1040, cloud orchestration module 1041, host physical machine set 1042, virtual machine set 1043, and container set 1044.

The computer 1001 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1030. As is well understood in the art of computer technology, and depending upon the technology, performance of a computer-implemented method may be distributed among multiple computers and/or between multiple locations. On the other hand, in this presentation of the computer-implemented method 300 and/or the computer-implemented method 900, detailed discussion is focused on a single computer, specifically computer 1001, to keep the presentation as simple as possible. Computer 1001 may be located in a cloud, even though it is not shown in a cloud in FIG. 10. On the other hand, computer 1001 is not required to be in a cloud except to any extent as may be affirmatively indicated.

The processor set 1010 includes one, or more, computer processors of any type now known or to be developed in the future. Processing circuitry 1020 may be distributed over multiple packages, for example, multiple, coordinated integrated circuit chips. Processing circuitry 1020 may implement multiple processor threads and/or multiple processor cores. Cache 1021 is memory that is located in the processor chip package(s) and is typically used for data or code that should be available for rapid access by the threads or cores running on processor set 1010. Cache memories are typically organized into multiple levels depending upon relative proximity to the processing circuitry. Alternatively, some, or all, of the cache for the processor set may be located “off chip.” In some computing environments, processor set 1010 may be designed for working with qubits and performing quantum computing.

Computer readable program instructions are typically loaded onto computer 1001 to cause a series of operational steps to be performed by processor set 1010 of computer 1001 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1021 and the other storage media discussed below. The program instructions, and associated data, are accessed by processor set 1010 to control and direct performance of the inventive methods. In the computer-implemented method 300 and/or the computer-implemented method 900, at least some of the instructions for performing the inventive methods may be stored in the block 1001′ of the computer-implemented method 300 and/or the computer-implemented method 900 in persistent storage 1013.

Communication fabric 1011 is the signal conduction path that allows the various components of computer 1001 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 1012 is any type of volatile memory now known or to be developed in the future. Examples include dynamic type random access memory (RAM) or static type RAM. Typically, volatile memory 1012 is characterized by random access, but this is not required unless affirmatively indicated. In computer 1001, the volatile memory 1012 is located in a single package and is internal to computer 1001, but, alternatively or additionally, the volatile memory may be distributed over multiple packages and/or located externally with respect to computer 1001.

Persistent storage 1013 is any form of non-volatile storage for computers that is now known or to be developed in the future. The non-volatility of this storage means that the stored data is maintained regardless of whether power is being supplied to computer 1001 and/or directly to persistent storage 1013. Persistent storage 1013 may be a read only memory (ROM), but typically at least a portion of the persistent storage allows writing of data, deletion of data and re-writing of data. Some familiar forms of persistent storage include magnetic disks and solid state storage devices. Operating system 1022 may take several forms, such as various known proprietary operating systems or open source Portable Operating System Interface-type operating systems that employ a kernel. The code included in the block of the computer-implemented method 300 and/or the computer-implemented method 900 typically includes at least some of the computer code involved in performing the inventive methods.

Peripheral device set 1014 includes the set of peripheral devices of computer 1001. Data communication connections between the peripheral devices and the other components of computer 1001 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1023 may include components such as a display screen, speaker, microphone, wearable devices (such as goggles and smart watches), keyboard, mouse, printer, touchpad, game controllers, and haptic devices. Storage 1024 is external storage, such as an external hard drive, or insertable storage, such as an SD card. Storage 1024 may be persistent and/or volatile. In some embodiments, storage 1024 may take the form of a quantum computing storage device for storing data in the form of qubits. In embodiments where computer 1001 is required to have a large amount of storage (for example, where computer 1001 locally stores and manages a large database) then this storage may be provided by peripheral storage devices designed for storing very large amounts of data, such as a storage area network (SAN) that is shared by multiple, geographically distributed computers. IoT sensor set 1025 is made up of sensors that can be used in Internet of Things applications. For example, one sensor may be a thermometer and another sensor may be a motion detector.

Network module 1015 is the collection of computer software, hardware, and firmware that allows computer 1001 to communicate with other computers through WAN 1002. Network module 1015 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1015 are performed on the same physical hardware device. In other embodiments (for example, embodiments that utilize software-defined networking (SDN)), the control functions and the forwarding functions of network module 1015 are performed on physically separate devices, such that the control functions manage several different network hardware devices. Computer readable program instructions for performing the inventive methods can typically be downloaded to computer 1001 from an external computer or external storage device through a network adapter card or network interface included in network module 1015.

WAN 1002 is any wide area network (for example, the internet) capable of communicating computer data over non-local distances by any technology for communicating computer data, now known or to be developed in the future. In some embodiments, the WAN 1002 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 1003 is any computer system that is used and controlled by an end user (for example, a customer of an enterprise that operates computer 1001), and may take any of the forms discussed above in connection with computer 1001. EUD 1003 typically receives helpful and useful data from the operations of computer 1001. For example, in a hypothetical case where computer 1001 is designed to provide a recommendation to an end user, this recommendation would typically be communicated from network module 1015 of computer 1001 through WAN 1002 to EUD 1003. In this way, EUD 1003 can display, or otherwise present, the recommendation to an end user. In some embodiments, EUD 1003 may be a client device, such as thin client, heavy client, mainframe computer, desktop computer and so on.

Remote server 1004 is any computer system that serves at least some data and/or functionality to computer 1001. Remote server 1004 may be controlled and used by the same entity that operates computer 1001. Remote server 1004 represents the machine(s) that collect and store helpful and useful data for use by other computers, such as computer 1001. For example, in a hypothetical case where computer 1001 is designed and programmed to provide a recommendation based on historical data, then this historical data may be provided to computer 1001 from remote database 1030 of remote server 1004.

Public cloud 1005 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1005 is performed by the computer hardware and/or software of cloud orchestration module 1041. The computing resources provided by public cloud 1005 are typically implemented by virtual computing environments that run on various computers making up the computers of host physical machine set 1042, which is the universe of physical computers in and/or available to public cloud 1005. The virtual computing environments (VCEs) typically take the form of virtual machines from virtual machine set 1043 and/or containers from container set 1044. It is understood that these VCEs may be stored as images and may be transferred among and between the various physical machine hosts, either as images or after instantiation of the VCE. Cloud orchestration module 1041 manages the transfer and storage of images, deploys new instantiations of VCEs and manages active instantiations of VCE deployments. Gateway 1040 is the collection of computer software, hardware, and firmware that allows public cloud 1005 to communicate through WAN 1002.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 1006 is similar to public cloud 1005, except that the computing resources are only available for use by a single enterprise. While private cloud 1006 is depicted as being in communication with WAN 1002, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1005 and private cloud 1006 are both part of a larger hybrid cloud.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of +8% or 5%, or 2% of a given value.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method for a mirror volume comparison, the computer-implemented method comprising:
executing asynchronous remote mirroring between a primary site and a secondary site;
making a first flash copy of first data at the primary site;
executing asynchronous remote copying of the first flash copy to a replica at the secondary site;
making a second flash copy of second data at the secondary site; and
performing an on-demand compare of the replica with the second flash copy to verify an accuracy of the asynchronous remote mirroring.

2. The computer-implemented method according to claim 1, further comprising:
stopping the first data from being updated upon the making of the first flash copy; and
resuming updates to the first data following the making of the second flash copy of the second data.

3. The computer-implemented method according to claim 1, wherein the making of the second flash copy comprises:
waiting for the secondary site to reach a consistency point equal to a point at which the first flash copy is created; and
making the second flash copy at the consistency point following the waiting.

4. The computer-implemented method according to claim 1, wherein the asynchronous remote copying of the first flash copy to the replica at the secondary site is non-instantaneous.

5. The computer-implemented method according to claim 1, wherein the second flash copy is an in-band flash copy.

6. The computer-implemented method according to claim 1, wherein:
the making of the first flash copy of the first data at the primary site comprises making first flash copies of multiple volumes of the first data,
the asynchronous remote copying of the first flash copy to the replica at the secondary site comprises asynchronous remote copying of the first flash copies to multiple replicas, and
the making of the second flash copy of the second data at the secondary site comprises making flash copies of multiple volumes of the second data.

7. The computer-implemented method according to claim 1, wherein the on-demand compare is a static compare of the replica with the second flash copy.

8. A computer program product for a mirror volume comparison, the computer program product comprising one or more computer readable storage media having computer readable program code collectively stored on the one or more computer readable storage media, the computer readable program code being executed by a processor of a computer system to cause the computer system to perform a method comprising:
executing asynchronous remote mirroring between a primary site and a secondary site;
making a first flash copy of first data at the primary site;
executing asynchronous remote copying of the first flash copy to a replica at the secondary site;
making a second flash copy of second data at the secondary site; and
performing an on-demand compare of the replica with the second flash copy to verify an accuracy of the asynchronous remote mirroring.

9. The computer program product according to claim 8, wherein the method further comprises:
stopping the first data from being updated upon the making of the first flash copy; and
resuming updates to the first data following the making of the second flash copy of the second data.

10. The computer program product according to claim 8, wherein the making of the second flash copy comprises:
waiting for the secondary site to reach a consistency point equal to a point at which the first flash copy is created; and
making the second flash copy at the consistency point following the waiting.

11. The computer program product according to claim 8, wherein the asynchronous remote copying of the first flash copy to the replica at the secondary site is non-instantaneous.

12. The computer program product according to claim 8, wherein the second flash copy is an in-band flash copy.

13. The computer program product according to claim 8, wherein:
the making of the first flash copy of the first data at the primary site comprises making first flash copies of multiple volumes of the first data,
the asynchronous remote copying of the first flash copy to the replica at the secondary site comprises asynchronous remote copying of the first flash copies to multiple replicas, and
the making of the second flash copy of the second data at the secondary site comprises making flash copies of multiple volumes of the second data.

14. The computer program product according to claim 8, wherein the on-demand compare is a static compare of the replica with the second flash copy.

15. A computing system comprising:
a processor;
a memory coupled to the processor; and
one or more computer readable storage media coupled to the processor, the one or more computer readable storage media collectively containing instructions that are executed by the processor via the memory to implement a method comprising:
executing asynchronous remote mirroring between a primary site and a secondary site;
making a first flash copy of first data at the primary site;
executing asynchronous remote copying of the first flash copy to a replica at the secondary site;
making a second flash copy of second data at the secondary site; and
performing an on-demand compare of the replica with the second flash copy to verify an accuracy of the asynchronous remote mirroring.

16. The computing system according to claim 15, wherein the method further comprises:
stopping the first data from being updated upon the making of the first flash copy; and
resuming updates to the first data following the making of the second flash copy of the second data.

17. The computing system according to claim 15, wherein the making of the second flash copy comprises:
waiting for the secondary site to reach a consistency point equal to a point at which the first flash copy is created; and
making the second flash copy at the consistency point following the waiting.

18. The computing system according to claim 15, wherein the asynchronous remote copying of the first flash copy to the replica at the secondary site is non-instantaneous.

19. The computing system according to claim 15, wherein the second flash copy is an in-band flash copy.

20. The computing system according to claim 15, wherein:
the making of the first flash copy of the first data at the primary site comprises making first flash copies of multiple volumes of the first data,
the asynchronous remote copying of the first flash copy to the replica at the secondary site comprises asynchronous remote copying of the first flash copies to multiple replicas,
the making of the second flash copy of the second data at the secondary site comprises making flash copies of multiple volumes of the second data, and
the method further comprises scheduling to use minimum resources in minimal time.
